(19) United States
(12) Patent Application Publication
(10) Pub. No.: US 2025/0294320 A1
(43) Pub. Date: Sep. 18, 2025

(54) Wi-Fi Apparatus

(71) Applicant: Board of Trustees of Michigan State University, East Lansing, MI (US)

(72) Inventors: Huacheng ZENG, Okemos, MI (US); Kunzhe SONG, East Lansing, MI (US)

(21) Appl. No.: 19/072,327

(22) Filed: Mar. 6, 2025

Related U.S. Application Data
(60) Provisional application No. 63/565,399, filed on Mar. 14, 2024.

(51) Int. Cl. H04W 4/029; H04W 84/12

(52) U.S. Cl. CPC H04W 4/029; H04W 84/12

(57) ABSTRACT

A Wi-Fi based sensing system comprising a Wi-Fi device, a sensing device, and a radio frequency (RF) mixer. The Wi-Fi device is configured to transmit orthogonal frequency-division multiplexing (OFDM) signals. The sensing device is configured to be connected to or spaced near the Wi-Fi device. The sensing device comprises a deep neural network (DNN), an antenna for receiving the OFDM signal transmitted from the Wi-Fi device and an antenna for receiving OFDM signals reflected from target objects. The Wi-Fi based sensing system determines movement of the target objects based on phase-coherent sensing.

### CROSS-REFERENCE TO RELATED APPLICATION

This application claims the benefit of U.S. Provisional Application No. 63/565,399, filed on Mar. 14, 2024, which is incorporated by reference herein.

### BACKGROUND

The present disclosure relates to a system and method for human detection using Wi-Fi signals.

Fine-grained human activity recognition is an important research area that has attracted efforts from different communities. In computer vision, many camera-based technologies have been developed that can detect human body key points with high accuracy. However, these camera-based techniques face significant challenges in large-scale deployment, including video privacy concerns and high data transmission bandwidth requirements. Furthermore, in scenarios with poor illumination, or when subjects are occluded, the performance of cameras diminishes significantly, resulting in inaccurate detections. In light of these issues, radio sensing methods have been regarded as a complementary approach. These methods involve collecting data through radio devices and using camera-based technologies to synchronously extract human body part annotations, which then serve as supervisory signals for the radio data. Unlike visible light, which can be obstructed by walls and objects, radio signals can penetrate these barriers and reflect off the human body. This capability allows for stable tracking of the human body in diverse scenarios, overcoming the limitations of camera-based technologies.

Among radio sensing methods, Wi-Fi channel state information (CSI) based sensing stands out due to the prevalence and cost-effectiveness of Wi-Fi devices. Current methods primarily utilize CSI data, obtained directly from commercial Wi-Fi devices, to estimate the spatial coordinates of human body parts. However, CSI based Wi-Fi sensing has two fundamental limitations: First, CSI measurement requires at least two Wi-Fi devices—one for transmitting and one for receiving. Due to the physical separation between the Wi-Fi transmitter and receiver, the measured CSI inevitably suffers from carrier frequency offset (CFO), sampling time offset (STO), and carrier phase offset (CPO). While CFO and STO can be corrected, CPO cannot, which imposes a fundamental limit on the performance of CSI-based sensing methods. Second, the CSI measured by a Wi-Fi device is a reflection of its surrounding environment. Due to CPO, CSI-based sensing methods are susceptible to environmental changes. This susceptibility impedes the effective transfer of trained deep learning models to new scenes, thereby limiting the widespread application of CSI-based sensing in real-world Wi-Fi systems.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

The present disclosure presents SiWiS, a joint hardware and software design that integrates radio sensing capabilities into commercial Wi-Fi devices for fine-grained human activity detection. The SiWiS does not emit any radio signals; instead, it leverages an Orthogonal Frequency Division Multiplexing (OFDM) signal of the Wi-Fi device for sensing. Since the transmitter and receiver are co-located on the same Wi-Fi device, the SiWiS does not suffer from CFO, STO, or CPO, thereby addressing the two fundamental limitations of CSI based sensing methods. The SiWiS comprises two main components: (i) a new hardware module that can be attached to a commercial Wi-Fi device, and (ii) a deep neural network (DNN) optimized for concurrent human mask segmentation and pose estimation. The combination of these components enables a Wi-Fi device to detect fine-grained human activities using the Wi-Fi OFDM signals.

For the design of SiWiS, since Wi-Fi devices operate in time-division duplexing (TDD) mode, preventing them from receiving reflective signals while transmitting, an array of patch antennas is installed on the surface of the device and incorporate an RF circuit component dedicated to receiving these reflective signals. A key challenge involves the RF circuit design. The reflective signals received by SiWiS are in RF form and need to be converted to intermediate frequency (IF) for feature extraction. On one hand, traditional methods, such as using a Local Oscillator (LO) for down-conversion, face limitations due to CFO and STO between the Wi-Fi modem and the sensing oscillator. On the other hand, Wi-Fi modems are highly integrated with no user-accessible external interfaces, making it impossible to obtain the necessary frequency and timing clocks for the sensing circuit, even though they are physically co-located. To address this challenge, the SiWiS employs a self-mixing architecture that involves mixing reflective Wi-Fi signals with a “local” ambient Wi-Fi OFDM signal. This self-mixing approach not only enables phase coherent sensing but also ensures compatibility with commercial Wi-Fi devices.

To achieve fine-grained human activity detection, SiWiS employs a dual-branch DNN designed for concurrent mask segmentation and pose estimation. It first extracts feature vectors from the input Wi-Fi-based sensing signal using a signal encoder. Given that reflections from certain body parts may not be captured within short time intervals, potentially resulting in de-emphasized or missing key information, SiWiS incorporates a self-attention block into the signal encoder to establish connections across longer sequences of signal frames. Furthermore, to enhance the adaptability of the signal encoder to both mask segmentation and pose estimation tasks, SiWiS employs a cross-attention block to establish fine-grained spatial pixel feature connections.

In one aspect of the disclosure, Wi-Fi based sensing system, includes a Wi-Fi device configured to transmit orthogonal frequency-division multiplexing (OFDM) signals and a sensing device operably connected to the Wi-Fi device. The sensing device had a first antenna configured to receive a local copy. The local copy is the OFDM signal transmitted by the Wi-Fi device. At least two antennas are configured to receive reflections. The reflections are reflections of the OFDM signal from target objects. A radio frequency (RF) mixer is configured to mix the local copy and the reflections generate a mixer signal and detect the target objects based on phase-coherent sensing. A neural network is optimized for human mask segmentation and pose estimation.

In another aspect of the disclosure a stand-alone sensing device for coupling to a Wi-Fi device has a first antenna configured to receive a local copy. The local copy is an OFDM signal transmitted by the Wi-Fi device. At least two antennas are configured to receive reflections. The reflections are reflections of the OFDM signal from target objects. A radio frequency (RF) mixer is configured to mix the local copy and the reflections generate a mixer signal and detect the target objects based on phase-coherent sensing. A neural network is optimized for human mask segmentation and pose estimation.

In another aspect of the disclosure, a method for Wi-Fi based human activity recognition includes transmitting, by a Wi-Fi device, an orthogonal frequency-division multiplexing (OFDM) signal, receiving, by one or more antennas attached to the Wi-Fi device, a local copy, the local copy is the OFDM signal transmitted by the Wi-Fi device, receiving, by one or more antennas attached to the Wi-Fi device, reflections, the reflections are reflections of the OFDM signal from target objects, mixing, by a radio frequency (RF) mixer, the local copy and the reflections to produce a phase-coherent signal, processing, by a deep neural network, the phase-coherent signal to extract human movement features to form a processed phase-coherent signal and estimating human pose and mask segmentation using the processed phase-coherent signal.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 depicts a schematic diagram of SiWiS;

FIG. 2 depicts the SiWiS in an environment with a target object;

FIG. 3 depicts an illustration of the output signal y(t) of the mixer;

FIG. 4 depicts the amplitude and phase of g(dᵢ);

FIG. 5 depicts the amplitude and phase of CSI measured over 100 consecutive Wi-Fi packets in a static scenario;

FIG. 6 depicts feature extraction operations;

FIG. 7 depicts measured P versus distance D;

FIG. 8 depicts an illustration of the amplitude and phase of the output signal y(t) of the mixer when the excitation signal is from Bluetooth;

FIG. 9 depicts a deep neural network (DNN) framework of the SiWiS;

FIG. 10 depicts a dice loss mask segmentation; and

FIG. 11 depicts weighted MSE loss improves pose estimation.

Corresponding reference numerals indicate corresponding parts throughout the several views of the drawings.

### DETAILED DESCRIPTION

Example embodiments will now be described more fully with reference to the accompanying drawings.

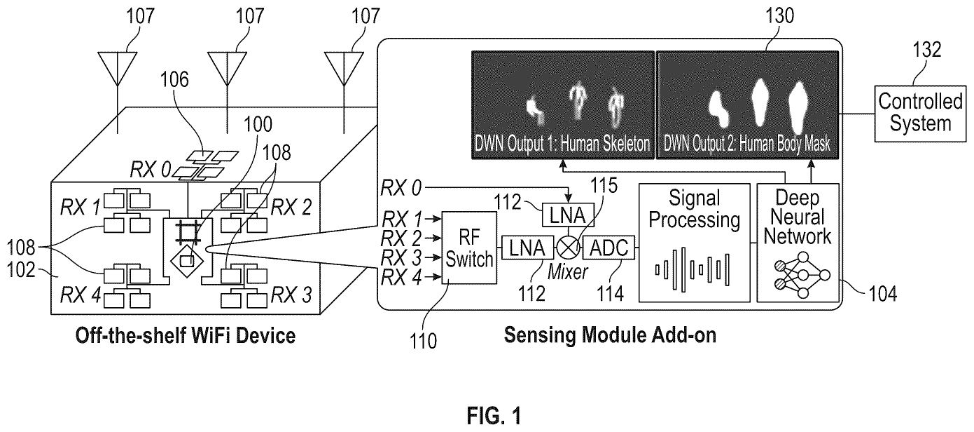

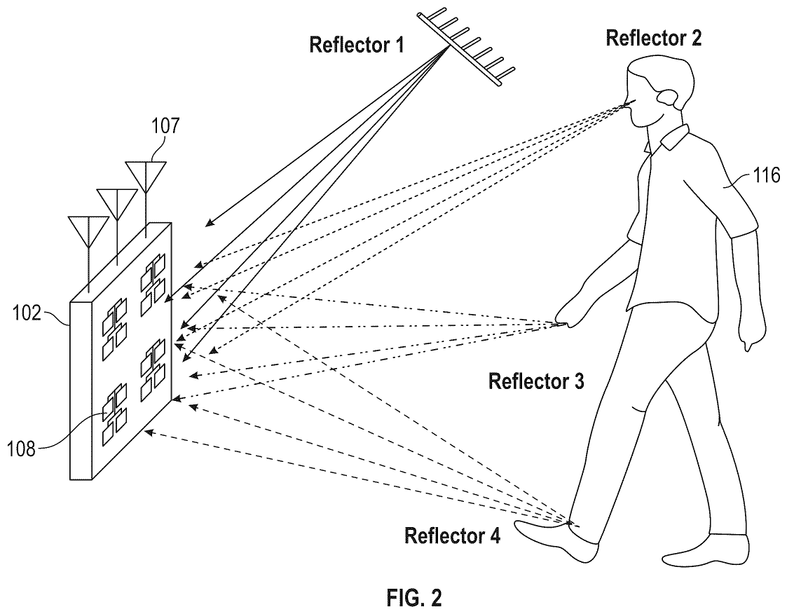

Referring now to FIGS. 1 and 2, a schematic diagram of SiWiS 100 Is depicted. To achieve phase-coherent sensing on a single Wi-Fi device, the SiWiS 100 is hardware that can be attached to a commercial Wi-Fi device 102 and comprises a deep neural network 104 (DNN) optimized for concurrent human mask segmentation and pose estimation. If the commercial Wi-Fi device 102 is of a small size and does not have enough surface for patch antennas (described below), the SiWiS 100 can be placed in the close proximity of the commercial Wi-Fi device 102. The commercial Wi-Fi device 102 may be a Wi-Fi router, a laptop, a desktop computer, a smart TV, or combinations thereof. The combination of these components enables the commercial Wi-Fi device 102 to detect fine-grained human activities using its OFDM signals. The SiWiS 100 employs two techniques: (i) self-mixing of Wi-Fi OFDM signals, and (ii) the patch antennas 106 for sensing directivity. These two techniques enable individual Wi-Fi devices to achieve Doppler-radar-like phase-coherent sensing capabilities.

One dipole/patch antenna 106 (RX0) was installed oriented toward the Wi-Fi communication antennas 107 to obtain a local copy of Wi-Fi OFDM signal, which will be used as the local oscillator (LO) for the radio frequency (RF) mixer 115. Multiple patch antennas 108 (RX1 through RX4) are installed on one side of the commercial Wi-Fi device 102 to receive the reflective OFDM signals from target objects 116. At least two patch antennas 108 may be used in the system outside the local copy patch antennas. The use of patch antennas 108 serves two purposes: (i) to reduce self-interference from Wi-Fi TX antennas, and (ii) to maximize the strength of received signals reflected from the target objects 116. To reduce the hardware complexity, an RF switch 110 is used for the sharing of a single RF chain. The received signals from the patch antennas 108 are first amplified using a low noise amplifier 112 (LNA) and then coupled to a mixer and mixed with the local copy of the OFDM signal from RX0 (used as a local oscillator (LO))) for down conversation also through a low noise amplifier 112. The output of mixer is sampled using an analog-to-digital converter 114 (ADC) for digital signal processing and learning-based inference.

The communication and sensing subsystems of the SiWiS 100 are physically independent. These two subsystems do not interfere with each other. On the other hand, the SiWiS 100 is a joint communication and sensing system. The sensing subsystem does not emit radio waves. Instead, it leverages ambient Wi-Fi OFDM signals to realize its sensing functions. The SiWiS 100 relies on Wi-Fi OFDM signals for sensing. It does not have spectrum coexistence issues with Wi-Fi communication systems. Like a Doppler radar, it is suited for detecting moving objects, not static objects.

For simplicity, one sensing antenna of the SiWiS 100 is considered. Denote x(t) as the baseband OFDM signal of a Wi-Fi frame. Then, the Wi-Fi RF signal can be written as s(t)=x(t)e^{j2πf}^{_{c}}^{t}, where f_{c} is the carrier frequency of a Wi-Fi channel at 2.4 GHz or 5 GHz. Denote [symbol] and [symbol] as the sets of static and moving reflectors in the environment, as shown in FIG. 2. Then, the RF signal received by one sensing antenna can be written as (equation 1):

$$r ( t ) = {\sum }_{i ∈ ℛ ⋃ ℳ} {α}_{i} x ( t - {τ}_{i} ) {e}^{j 2 π {f}_{c} ( t - {τ}_{i} )}$$

where αᵢ∈ [symbol] and τᵢ ∈ [symbol] are the attenuation and delay of the reflective signal from reflector i∈ [symbol] ∪ [symbol] .

As shown in FIG. 1, the SiWiS 100 mixes the received RF signal (from RX1, RX2, RX3, or RX4) 108 with the local copy from its antenna RX0 106. Since RX0 106 is physically close to Wi-Fi's TX antennas, the LoS path is dominant compared to the nonLoS paths. Therefore, s(t) is used to approximate the LO for mixing. Then, the output of the mixer can be written as (equation 2):

$$y ( t ) = r ( t ) {s ( t )}^{*} = {\sum }_{i ∈ ℛ ⋃ ℳ} {α}_{i} x ( t - {τ}_{i} ) {x ( t )}^{*} {e}^{- j 2 π {f}_{c} {τ}_{i}}$$

where (⋅)* is complete conjugate operator.

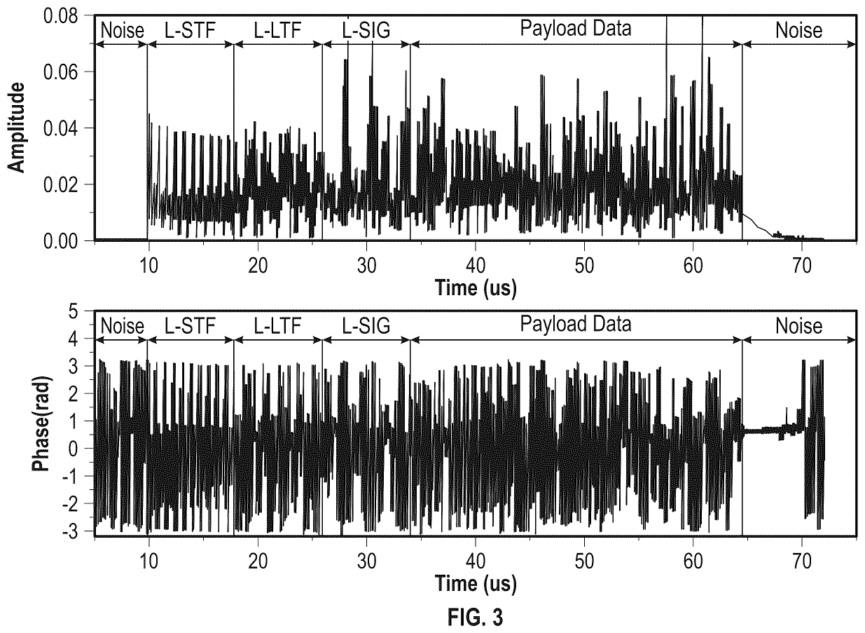

Denote dᵢ as the distance between the SiWiS 100 and reflector i∈ [symbol] ∪ [symbol] . Then, equation 2 can be written as (equation 3):

$$y ( t ) = {\sum }_{i ∈ ℛ ⋃ ℳ} {α}_{i} x ( t - \frac{2 {d}_{i}}{c} ) {x ( t )}^{*} {e}^{- j \frac{4 π}{c} {f}_{c} {d}_{i}}$$

where c is light speed. A sample of y(t) from the RF mixer is depicted in FIG. 3. L-STF corresponds to two OFDM symbols of the preamble, L-LTF corresponds to two more symbols of the preamble and L-SIG correspond to 1OFDM symbols in the preamble. After the preamble, the payload is illustrated. Because of the stability of the preamble signal, the system detects and determines the object using the preamble time period. Suppose that the mixer's output signal is sampled with time interval Δt (50 ns for 20 MHz Wi-Fi). Then, the digital version of y(t) can be written as (equation 4):

$$y ( n Δ t ) = {\sum }_{i ∈ ℛ ⋃ ℳ} {α}_{i} x ( n Δ t - \frac{2 {d}_{i}}{c} ) {x ( n Δ t )}^{*} {e}^{- j \frac{4 π}{c} {f}_{c} {d}_{i}}$$

where n is the signal sample index in the time domain.

Using y(nΔt) in equation 4, n=1, 2, . . . , to infer the movement pattern of an object is challenging for two reasons. First, the Wi-Fi OFDM signal x(t) is time-varying, depending on its payload data. Second, the Wi-Fi signal transmission power is not fixed and is subject to power adaptation control. These factors make it challenging to extract stable features from the mixer's output signal. To address this challenge, the preamble in each Wi-Fi frame is taken advantage of. The output signal y(nΔt) is summed over the data sampled corresponding to the L-LTF in a Wi-Fi frame. Denote [symbol] the set of data samples corresponding to the L-LTF in a Wi-Fi frame. Then, it is defined (equation 5):

$$Y = {\sum }_{n ∈ {ℬ}_{ltf}} y ( n Δ t )$$

Based on equation 4, equations 6, 7, and 8 are written as:

$$Y \overline{\overline{( a )}} {\sum }_{i ∈ ℛ} {\sum }_{n ∈ {ℬ}_{l t f}} {α}_{i} x ( n Δ t - \frac{2 {d}_{i}}{c} ) {x ( n Δ t )}^{*} {e}^{- j \frac{4 π}{c} {f}_{c} {d}_{i}} + {\sum }_{i ∈ ℳ} {\sum }_{n ∈ {ℬ}_{l t f}} {α}_{i} x ( n Δ t - \frac{2 {d}_{i}}{c} ) {x ( n Δ t )}^{*} {e}^{- j \frac{4 π}{c} {f}_{c} {d}_{i}}$$

$$\overline{\overline{( b )}} {C}_{s} + {\sum }_{i ∈ ℳ} {α}_{i} ( {\sum }_{n ∈ {ℬ}_{l t f}} x ( n Δ t - \frac{2 {d}_{i}}{c} ) {x ( n Δ t )}^{*} ) {e}^{- j \frac{4 π}{c} {f}_{c} {d}_{i}}$$

where C_{S}∈ [symbol] is a constant complex number. Equation 6 results from separating the reflections from static and mobile objects. Equation 8 follows from the fact that the reflection from static objects remains constant after summing the L-LTF samples.

The term in the parenthesis in equation 8. Define (equation 9):

$$g ( {d}_{i} ) = {\sum }_{n ∈ {ℬ}_{l t f}} x ( n Δ t - \frac{2 {d}_{i}}{c} ) {x ( n Δ t )}^{*}$$

where c=3×108 m/s, Δt=50 ns for 20 MHz Wi-Fi. For n∈ [symbol] , x(nΔt) is the waveform of L-LTF.

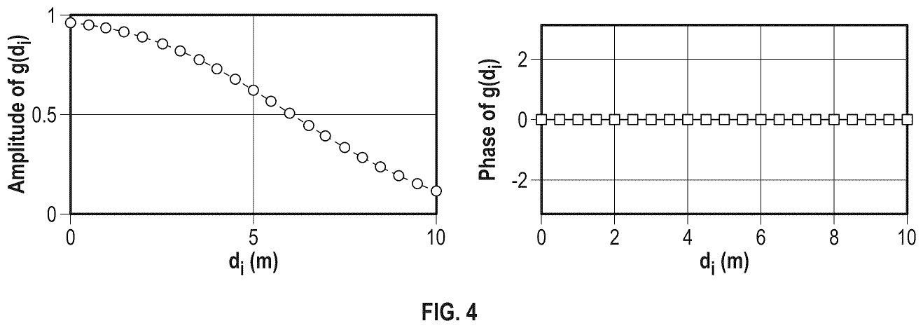

FIG. 4 plots the numerical results of g(dᵢ). Evidently, when dᵢ≤10 m, g(dᵢ) is a real number, i.e., g(dᵢ)∈ [symbol] . Denote [⋅]_{ac} as the operation of removing the DC component of a signal vector. Then, it is defined as (equation 10):

$${[ Y ]}_{a c} = {\sum }_{i ∈ M} {α}_{i} ( g ( {d}_{i} ) ) ( {e}^{- j \frac{4 π}{c} {f}_{c} {d}_{i}} )$$

Equation 10 characterizes the relationship between the observed signal [Y]_{ac} and object distance dᵢ. Given that aᵢ, c, f_{c}, dᵢ, and g(dᵢ) in equation 10 are all real numbers, the following lemma can be derived.

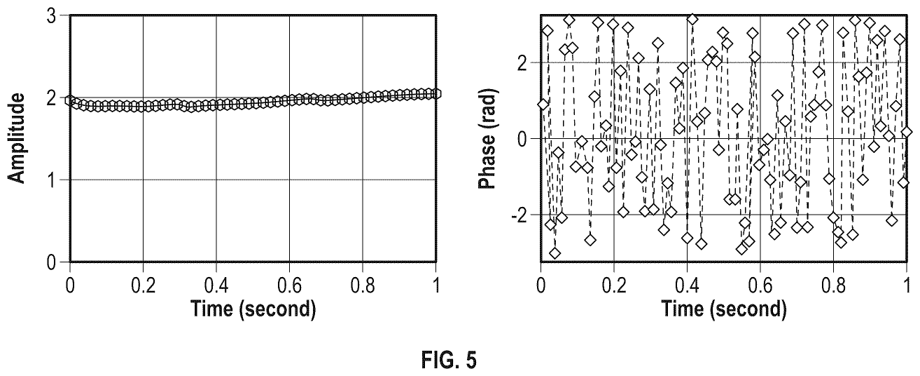

If there is a single moving object of small physical size, then the phase of the observed signal, [Y]_{ac}, is a linear function of the object distance d. The SiWiS 100 achieves a deterministic (linear) relationship between its observed signal phase and object moving distance. This is a sharp contrast to existing CSI-based sensing approaches, where the CSI phase appears to be random as shown in FIG. 5. This feature makes it possible for the SiWiS 100 to detect sub-centimeter movements, achieving phase-coherent sensing like Doppler radars.

The commercial Wi-Fi device 102 may use different power levels for transmitting various data packets, depending on channel condition and packet type. While this power adaptation affects the amplitude of the observed signal, [Y]_{ac}, it does not impact their phase. Therefore, the phase feature is resilient to Wi-Fi power adaptation. This was derived under the assumption that the target object 116 is a single moving object of small physical size. There may be multiple moving target objects 116, or the target object 116 size may be large. In this case, multiple sensing antennas to differentiate the target objects 116 in the spatial domain and on the DNN 104 to disentangle the underlying relationship between the observed signal features and the object movements is relied upon.

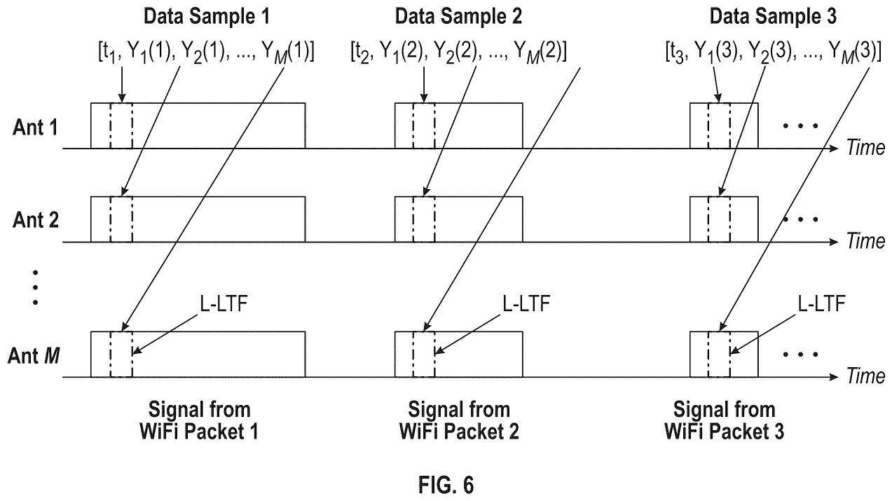

Based on the above analysis, feature extraction operations of the SiWiS 100 are summarized in FIG. 6. The output signal of the mixer is denoted as yₘ(nΔt, k), where m is the sensing antenna index, n is the data sample index of a Wi-Fi packet, Δt is the time sampling interval, and k is the index of detected Wi-Fi packets. Then, the signal feature is defined by letting: Yₘ(k)=[ [symbol] Yₘ(nΔt,k)]_{ac}.

Collectively, the feature data tensor is written as (equation 11):

Sₖ=[tₖ,Y₁(k),Y₂(k), . . . ,Yₘ(k)],1≤k≤K_{packet}
where M is the number of sensing antennas, tₖ is the timestamp of Wi-Fi packet k, and K_{packet} is the total number of detected Wi-Fi packets. Sₖ, k=1, 2, . . . , is then streamed into the dual-branch DNN 104 for optimized human pose estimation and mask segmentation. Pose estimation and mask segmentation generate data signals that may be used to display an image on a display 130 and/or controlled a controlled system 132 such as an alarm system. A warning signal may be generated by a controller system. The controlled system may be an actuator for closing or opening doors or windows of a building to keep people or to allow egress.

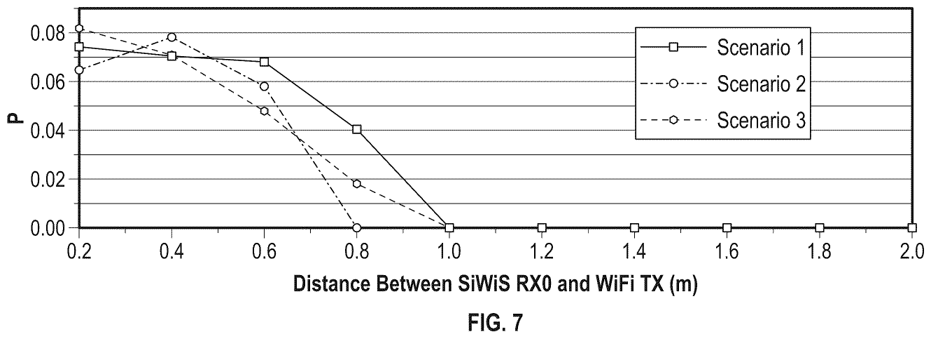

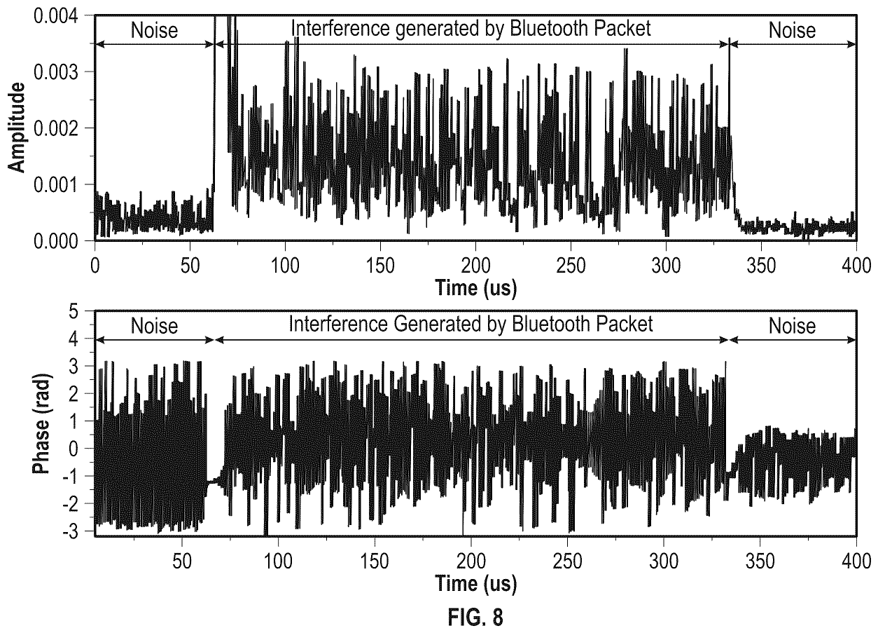

To determined excitation OFDM signal is from its host Wi-Fi device or from a non-host Wi-Fi device by the SiWiS 100, a new metric P=τₘ₌₁^{M}|Yₘ(k)|². The host Wi-Fi device is the commercial Wi-Fi device 102 that the SiWiS 100 is connected too. FIG. 7 displays measurement results comparing P and D across three different scenarios. It can be seen that P decreases rapidly as D increases, and P=0 for D≥1 meter. Therefore, the SiWiS 100 can use the value of P to determine whether its excitation signal is from its host Wi-Fi device, the commercial Wi-Fi device 102. The SiWiS 100 can discard all received Wi-Fi frames where P≤Pₜₕᵣₑₛ, where Pₜₕᵣₑₛ is a threshold that can be empirically set (e.g., Pₜₕᵣₑₛ=0.05 in this case). By doing this, the SiWiS 100 will effectively eliminate interference from all Wi-Fi devices located 0.6 meters away. If its excitation signal is not from a Wi-Fi device, the SiWiS 100 can easily identify it based on its mixer output signal. As an example, Bluetooth is used to generate the excitation signal for the SiWiS 100. The Bluetooth device is positioned 0.1 meters from the SiWiS 100. FIG. 8 shows the mixer output of the SiWiS 100. Comparing to FIG. 3 (Wi-Fi excitation), the mixer output signal is more than 20 dB weaker and lacks the L-STF and L-LTF signatures when the excitation signal originates from Bluetooth. These differences allow the SiWiS 100 to easily identify and then exclude the interference from non-Wi-Fi devices.

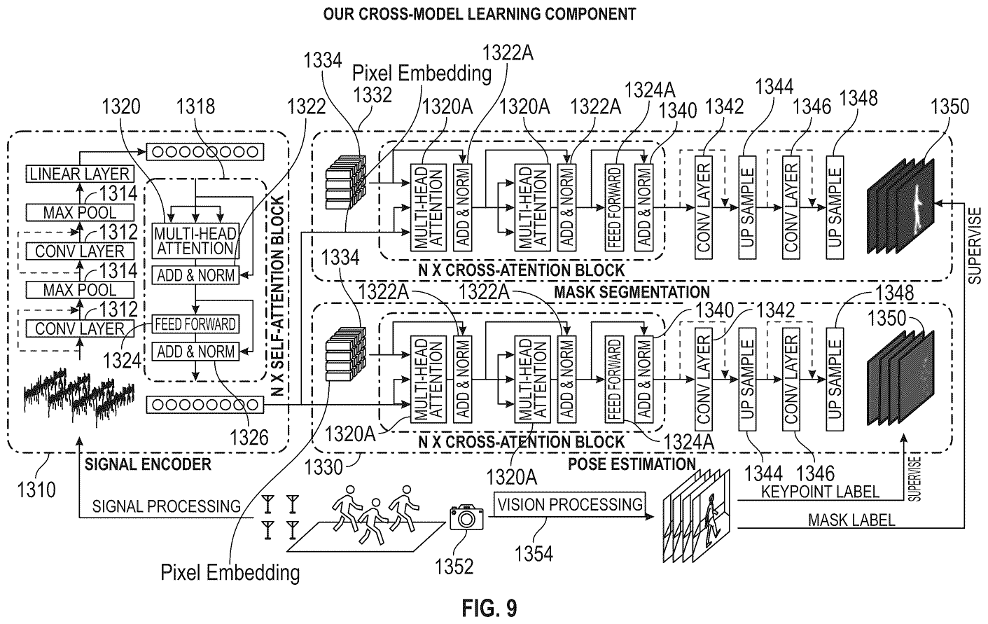

The SiWiS 100 focuses on human activity recognition as a use case for the sensing approach. Due to the complexity of RF sensing, the DNN 104 is an end-to-end DNN. The SiWiS 100 employs a cross-modal supervision approach for training of the DNN 104, transferring knowledge from vision-based human recognition models to Wi-Fi-based models. At high level, it comprises two components: vision processing and signal processing, as shown in FIG. 9. During the training stage, both video frames and Wi-Fi-based sensing signals are used, aligning them by their respective timestamps. In the inference, stage, Wi-Fi-based sensing signals are relied upon.

For the input Wi-Fi-based sensing signals in this example, a signal encoder 1310 has two combinations of convolution layers 1312 and two MaxPool circuits 1314 in series followed by a linear layer 1316 are used to extract temporal features. To enhance the model's ability of capturing feature correlations over time, one or more self-attention blocks 1318 are used for processing longer periods of sensing signals. The attenuation block 1318 has a multi-head attenuation block 1320 followed by an add and normalization block 1322, The add part sums together the feed forward and the output of the attenuation block 1320. The normalization part is used to make training easier. A feed forward block 1324 and another add and normalization block 1326 may be used to improve the training. The output of the signal encoder 1310 (from the add and normalization block is provided to a pose estimation block 1330 and a mask segmentation block 1332. Each block 1330 and 1332 are described together. A pixel embedding block 1334 and the output of the encoder are provided to a multi-head attenuation block 1320A followed by an add and normalization block 1322A. Multiples of blocks 1320A and 1322A may be used in series. In this case two. A feed forward block 1324A and another add and normalize block 1340 may be used. A convolution layer 1342, an up sample layer 1344, a convolution layer 1346, and another up sample layer 1348 may be used to provide an output 1350. A time stamp carries continues through the system.

A camera 1352 and a vision processing system 1354 provides keypoint labels and mask labels to the pose estimation system 1330 and the mask segmentation block 1332, respectively. The labels are used as feedback for training. Each label is associated with a timestamp so that the timestamps may be coordinated with the WI-FI timestamps from the data.

In summary, preceding and following the self-attention block, two fully connected layers for dimension reduction and subsequent expansion are integrated, respectively. Then, parameter-free identity shortcuts to connect the inputs and outputs of the module are employed. With a reduction scale of X for the fully connected layers, the module's parameter amount is also reduced by a factor of X, significantly accelerating the model's training speed.

Given that the supervisory signals for the model are heatmaps generated by the vision process network, it is necessary to up sample the sensing signal features to match the dimensions of the heatmap features. Each Wi-Fi signal feature obtained from the signal encoder has a dimension of C×1×1, where C represents the number of channels. Then, a cross-attention block designed to produce feature maps with dimensions of C×h×w. Specifically, h×w trainable pixel embeddings are initialized and employ cross-attention to compute the attention weights of each pixel embedding towards each sensing signal feature. Subsequently, convolutional and up sampling layers are employed to increase the feature map size from h×w to h¹×w¹, aligning with the dimensions of the ground truth heatmap features.

A dice loss is integrated to resolve segmentation areas occupying over a few pixels in an image. The dice loss is formulated in a mask segmentation loss function as expressed (equation 12):

$${ℒ}_{mask} = {α}_{1} {\sum }_{i = 1}^{N} ( {y}_{i} log {x}_{i} + ( 1 - {y}_{i} ) log ( 1 - {x}_{i} ) ) + {α}_{2} ( 1 - \frac{2 {\sum }_{i = 1}^{𝒩} {x}_{i} {y}_{i}}{{\sum }_{i = 1}^{𝒩} {x}_{i}^{2} + {\sum }_{i = 1}^{𝒩} {y}_{i}^{2}} ) .$$

where xᵢ represents the predicted value, and yᵢ is the real class label. N is the number of pixels. a₁ and a₂ denote scalar weights utilized to balance the two losses.

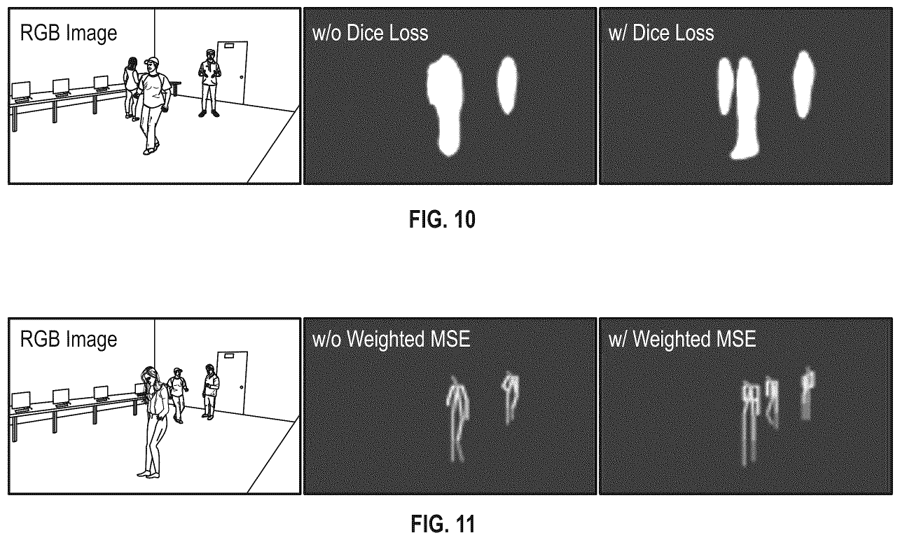

FIG. 10 illustrates the mask segmentation outcomes with and without the integration of the dice loss. It is evident that the integration of the dice loss can significantly improve the detection accuracy. For pose estimation, Mean Squared Error (MSE) loss is utilized. Since human key points typically occupy very few pixels in the image, applying MSE loss with an average regression error over all pixels may excessively emphasize background regions in the loss function.

A keyboard grouping process, [symbol] , organizes identity-free key points into individuals by grouping key points with smaller [symbol] distances between their tags. The expression of the pose estimation loss function is as follows (equation 13):

$${ℒ}_{p o s e} = ( y + 1 ) ⊙ {‖ \hat{y} - y ‖}_{2}^{2} + {ℒ}_{g r o u p}$$

where ŷ and y represent the prediction and ground truth heatmaps, respectively, and ⊙ denotes element-wise multiplication. FIG. 11 illustrates the pose estimation outcomes with and without the integration of weighted MSE loss. The integration of weighted MSE loss is effective to improve the detection accuracy. The overall loss function for the training process is the weighted sum of the mask segmentation loss and pose estimation loss (equation 14):

$$ℒ = {ℒ}_{m a s k} + {λℒ}_{p o s e}$$

where λ is a scalar weight used to balance the two losses.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A Wi-Fi based sensing system, comprising:
a Wi-Fi device configured to transmit orthogonal frequency-division multiplexing (OFDM) signals;
a sensing device operably connected to the Wi-Fi device, the sensing device comprising:
a first antenna configured to receive a local copy, the local copy is the OFDM signal transmitted by the Wi-Fi device; and
at least two antennas configured to receive reflections, the reflections are reflections of the OFDM signal from target objects;
a radio frequency (RF) mixer configured to mix the local copy and the reflections generate a mixer signal and detect the target objects based on phase-coherent sensing; and
a neural network optimized for human mask segmentation and pose estimation.

2. The Wi-Fi based sensing system of claim 1, wherein the Wi-Fi device is a router, a laptop, a desktop, or a smart TV.

3. The Wi-Fi based sensing system of claim 1 wherein the sensing device determines whether an excitation signal originates from the Wi-Fi device or another Wi-Fi device by measuring a power metric.

4. The Wi-Fi based sensing system of claim 1 wherein the at least two antennas are patches that attach to the Wi-Fi device.

5. The Wi-Fi based sensing system of claim 1 wherein the Wi-Fi device comprises a Wi-Fi antenna, said first antenna oriented to face the Wi-Fi antenna.

6. The Wi-Fi based sensing system of claim 1 wherein the first antenna is coupled to the mixer through a first low noise amplifier.

7. The Wi-Fi based sensing system of claim 6 wherein the at least two antennas are coupled to the mixer through a second low noise amplifier.

8. The Wi-Fi based sensing system of claim 7 wherein an RF switch is coupled between the at least two antennas.

9. The Wi-Fi based sensing system of claim 8 wherein an analog to digital converter coupling the mixer to the neural network.

10. The Wi-Fi based sensing system of claim 1 wherein the reflections are reflections of a preamble of the OFDM signals.

11. The Wi-Fi based sensing system of claim 1 wherein the neural network comprises a deep neural network trained using camera images with first timestamps and Wi-Fi signals using second timestamps.

12. A sensing device for coupling to a Wi-Fi device comprises:
a first antenna configured to receive a local copy, the local copy is an OFDM signal transmitted by the Wi-Fi device; and
at least two antennas configured to receive reflections, the reflections are reflections of the OFDM signal from target objects;
a radio frequency (RF) mixer configured to mix the local copy and the reflections generate a mixer signal and detect the target objects based on phase-coherent sensing; and
a neural network optimized for human mask segmentation and pose estimation.

13. A method for Wi-Fi based human activity recognition, comprising:
transmitting, by a Wi-Fi device, an orthogonal frequency-division multiplexing (OFDM) signal;
receiving, by one or more antennas attached to the Wi-Fi device, a local copy, the local copy is the OFDM signal transmitted by the Wi-Fi device;
receiving, by one or more antennas attached to the Wi-Fi device, reflections, the reflections are reflections of the OFDM signal from target objects;
mixing, by a radio frequency (RF) mixer, the local copy and the reflections to produce a phase-coherent signal;
processing, by a deep neural network, the phase-coherent signal to extract human movement features to form a processed phase-coherent signal; and
estimating human pose and mask segmentation using the processed phase-coherent signal.

14. The method for Wi-Fi based human activity recognition of claim 13 wherein the Wi-Fi device is a router, a laptop, a desktop, or a smart TV.

15. The method for Wi-Fi based human activity recognition of claim 13 wherein the method further comprises measuring a power metric and determining whether an excitation signal originates from the Wi-Fi device or another Wi-Fi device.

16. The method for Wi-Fi based human activity recognition of claim 13, wherein the one or more antennas are patches that attach to the Wi-Fi device.

17. The method for Wi-Fi based human activity recognition of claim 13 further comprising selecting moving and static objects.

18. The method for Wi-Fi based human activity recognition of claim 13 further comprising training the neural network by aligning timestamps of video frames with Wi-Fi based sensing signals.

19. The method for Wi-Fi based human activity recognition of claim 13 further comprising using a preamble of the OFDM signal to form the reflections.

20. The method for Wi-Fi based human activity recognition of claim 13 further comprising prior to mixing, amplifying the local copy and the reflections, and after analog to digital processing, mixing in a mixer signal prior to the neural network.
